(19) United States
(12) Patent Application Publication
(10) Pub. No.: US 2018/0134020 A1
(43) Pub. Date: May 17, 2018

(54) METHOD FOR PRODUCING COMPOSITE MATERIALS

(71) Applicant: BASF SE, Ludwigshafen (DE)

(72) Inventors: Detlef PFEIFER, Bad Duerkheim (DE); Georg DREISSIGACKER, Landau (DE)

(73) Assignee: BASF SE, Ludwigshafen (DE)

(21) Appl. No.: 15/571,541

(22) PCT Filed: May 3, 2016
(86) PCT No.: PCT/EP2016/059806

§ 371 Date: Nov. 3, 2017

(30) Foreign Application Priority Data
May 6, 2015 (EP) 15166529.6

(51) Int. Cl. B32B 27/40; B32B 27/30; B32B 27/26; B32B 27/12; B32B 27/06; B32B 7/14; D06N 3/14; B29C 33/40; B29C 33/42

(52) U.S. Cl. CPC B32B 27/40; B32B 27/306; B32B 27/26; B32B 27/12; B32B 27/065; B32B 2307/70; D06N 3/145; B29C 33/40; B29C 33/424; B32B 2305/72; B32B 2307/40; B32B 7/14

(57) ABSTRACT

Process for the preparation of multilayered composite materials comprising, as components:
(A) a backing material,
(B) optionally at least one tie layer and
(C) a polymer layer,
   wherein
a) a polymer layer (C) is formed using a mold,
b) optionally at least one organic adhesive is applied all over or partially to backing material (A) and/or to polymer layer (C) and then
c) polymer layer (C) is bonded with backing material (A) in point, strip or two-dimensional fashion,
   polymer layer (C) and/or the optionally at least one tie layer (B) being prepared from aqueous polymer dispersions which comprise at least one crosslinking agent C, the at least one crosslinking agent C being at least one polyisocyanate P which is blocked with at least one blocking agent BA.

The present invention relates to a process for the preparation of multilayered composite systems. In addition, the present invention relates to the use of multilayered composite systems according to the invention.

WO 2009/106496, WO 2009/106498, WO 2009/106499, WO 2009/106500 and WO 2009/106503 describe multilayered composite materials with agreeable optical and haptical properties. However, the properties of the composite materials described therein were still not entirely satisfactory.

The object is to make available processes which make possible the preparation of multilayered composite systems which exhibit an attractive visual outward appearance and an agreeable haptic quality and which in particular exhibit good aging and storage properties.

The processes according to claim 1 were accordingly found.

The process according to the invention is used for the preparation of multilayered composite materials comprising
(A) a backing material,
(B) optionally at least one tie layer and
(C) a polyurethane layer,
   wherein a polymer layer (C) is formed using a mold, optionally at least one organic adhesive is applied all over or partially to backing material (A) and/or to polymer layer (C) and then polymer layer (C) is bonded with backing material (A) in point, strip or two-dimensional fashion, polymer layer (C) and/or the optionally at least one tie layer (B) being prepared from aqueous polymer dispersions which comprise at least one crosslinking agent C, the at least one crosslinking agent C being at least one polyisocyanate P, the isocyanate groups of which are blocked at ambient temperature with at least one blocking agent BA.

Process for the preparation of multilayered composite materials comprising, as components:
(A) a backing material,
(B) optionally at least one tie layer and
C) a polymer layer,
wherein
a) a polymer layer (C) is formed using a mold,
b) optionally at least one organic adhesive is applied a over or partially to backing material (A) and/or to polymer layer (C) and then
c) polymer layer (C) is bonded with backing material (A) in point, strip or two-dimensional fashion,
   polymer layer (C) and/or the optionally at least one tie layer (B) being prepared from aqueous polymer dispersions which comprise at least one crosslinking agent C, the at least one crosslinking agent C being at least one polyisocyanate P, the isocyanate groups of which are blocked at ambient temperature with at least one blocking agent BA.

Process for the preparation of multilayered composite materials comprising, as components:
(A) a backing material,
(B) optionally at least, one tie layer and
(C) a polymer layer,
wherein
a) a polymer layer (C) is formed using a mold,
b) optionally at least one organic adhesive is applied all over or partially to backing material (A) and/or to polymer layer (C) and then
c) polymer layer (C) is bonded with backing material (A) in point, strip or two-dimensional fashion,
   polymer layer (C) and/or the optionally at least one tie layer (B) being prepared from aqueous polymer dispersions which comprise at least one crosslinking agent C, the at least one crosslinking agent C being at least one polyisocyanate P which is blocked with at least one blocking agent BA.

Processes according to the invention generally use a flat substrate as backing material (A). Flat substrates are in the context of the present invention those whose expansion in two dimensions is much greater than in the third dimension; for example, width and length of flat substrate (A) can each exceed the thickness by at least a factor of 100 and preferably by at least a factor of 1000.

In one embodiment, length and/or width of flat substrate (A) exceed the thickness by a factor of up to 1 000 000.

Length and width of flat substrate (A) can in each case be identical or, preferably, different. For example, the length of flat substrate (A) can exceed the width by a factor of 1.1 up to 100.

In one embodiment of the present invention, the length of flat substrate (A) lies in the range from 50 cm to 100 m, preferably up to 50 m, and particularly preferably up to 10 m.

In one embodiment of the present invention, the width of flat substrate (A) lies in the range from 10 cm to 5 m, preferably up to 2 m.

In one embodiment of the present invention, the thickness of flat substrate (A) lies in the range from 50 nm to 2 mm, preferably 100 μm up to 500 μm.

In one embodiment, flat substrate (A) is an “endless material”, which generally is used wound up and is used in a continuous process. In this connection, the length of the wound-up flat material (A) many times exceeds the width thereof.

Flat substrate (A) can consist of one or more materials. Preferably, flat substrate (A) is chosen from leather, textiles, artificial leather, foams, cellulose materials, stone, metal films, plastic films, wovens, nonwovens and composite films, such as metalized plastic films. Examples of preferred wovens or nonwovens are wovens or nonwovens of polyester and nonwovens of thermoplastic polyurethane (“TPU”). Examples of preferred plastic films are PVC films, polyethylene films, polypropylene films, or films of polystyrene, polyamide or polyester, in particular polyethylene terephthalate (“PET”). Examples of particularly preferred metal films are those of aluminum.

In another embodiment of the present invention, flat substrate is chosen from recyclate, for example from recycled plastic.

In one embodiment of the present invention, flat substrate (A) exhibits a modulus of elasticity in the range from 200 to 5000 N/mm², determinable for example according to DIN 53455. Suitable are in particular flat substrates with a modulus of elasticity in the range from 200 to 1000 N/mm2, which for example predominantly comprise polyethylene (HDPE or LDPE), in the, range from 1000 to 3500 N/mm², which for example predominantly comprise rigid PVC, or in the range from 4000 to 4500 N/mm², which predominantly comprise PET.

In one embodiment of the present invention, flat substrate is chosen from plastic films of additivated plastic. Suitable additives can, for example, be chosen from plasticizers, impact modifiers, stabilizers, colorants, fillers, reinforcing materials and waxes.

Preferred backing materials (A) are leather or textiles, in particular textiles, and also artificial leather. Textile fabrics (A), which in the context of the present invention are also known as textile (A) or textiles (A), can exhibit different manifestations. Wovens, felts, drawn-loop knits, formed-loop knits, waddings, scrims, nonwovens and microfiber nonwovens are suitable, for example.

In one embodiment, textiles (A) are uncoated. In another embodiment, textiles (A) are, for example, coated with PU/TPU/PVC (water-based or solvent-comprising).

Preferably textile (A) is a woven, formed-loop knit, nonwoven or drawn-loop knit.

Textile fabrics (A) can be prepared from cords, braids, ropes, yarns or threads. Textiles (A) can be of natural origin, for example cotton, wool or flax or synthetic, for example polyamide, polyester, modified polyester, polyester blended fabric, polyamide blended fabric, polyacrylonitrile, triacetate, acetate, polycarbonate, polyolefins, such as, for example, polyethylene and polypropylene, polyvinyl chloride, and also polyester microfibers and glass-fiber fabrics. Polyester, cotton and polyolefins, such as, for example, polyethylene and polypropylene, and also selected blended fabrics, chosen from cotton/polyester blended fabrics, polyolefin/polyester blended fabrics and polyolefin/cotton blended fabrics, are very particularly preferred.

Textile fabrics (A) can be untreated or treated, for example bleached, dyed and finished. Textile fabrics are preferably uncoated or coated on only one side.

In a specific embodiment of the present invention, textile fabric (A) concerns wovens, drawn-loop knits or preferably nonwovens in which, by coagulation, at least one polymer, for example polyimide or in particular polyurethane, has been precipitated, but preferably so that the relevant textile fabric retains its breathability or air permeability. For example, polymers can be precipitated by coagulation by first preparing a solution of a polymer in a “good” solvent; for polyurethanes, N,N-dimethylformamide (DMF), tetrahydrofuran (THF) and N,N-dimethylacetamide (DMA), for example, are suitable. First a porous film of the relevant polymer is precipitated from this solution, for example by exposing the solution to the vapors of a “poor” solvent which can neither dissolve or swell the relevant polymer. For many polymers, water and methanol are suitable poor solvents, water being preferred. If it is desired to use water as poor solvent, the solution can for example be exposed to a humid atmosphere. The porous film thus obtained is removed and transferred onto the relevant textile fabric. Before or after this transferring the remainder of the good solvent is removed, for example by rinsing with a poor solvent.

In a completely specific embodiment of the present invention, the material is a poromer in which porosities are generated in polymer precipitated as described above, e.g. by washing out salts or according to other methods, such as are described, e.g., in chapter 6 ff. of the book New Materials Permeable to Water Vapor, Harro Träubel, Springer Verlag 1999.

Textile fabrics (A) can be finished; in particular,they are finished easy-care, flameproof, water-repellant and/or oil-repellant.

Textile fabrics (A) can exhibit a weight per unit area in the range 10 to 3000 g/m²; from 50 to 300 g/m² are preferred.

In one embodiment of the invention, backing material (A) concerns composite materials of a textile with a membrane film M. Membrane films M can, for example, be composed essentially of polycarbonate, polyester, polyurethane, polytetrafluoroethylene or mixtures thereof. Preferred membrane films M exhibit a high water vapor permeability (Moisture Vapor Transmission Rate—(MVTR)—of greater than 800 g/m²24 h according to DIN 53122) but only a low liquid water permeability (water column >50 mbar according to DIN 20811). Suitable membrane films M are available, for example, under the trade names GoreTex®, Sympatex®, Bayfol®, Dureflex®, Makrofol®, Platilon®, Porelle®, PROCHIMIR®, Advanta™, Provecta™, Orkesta™, Texiron®.

Multilayered composite system according to the invention can additionally exhibit at least one tie layer (B) which can be formed all over or partially.

Tie layer (B) can, for example, be an open-work, that is not all over, distinctive layer, preferably of a cured organic adhesive.

Suitable organic adhesives can, for example, be based on polyurethanes, polyamides, polyesters, polyethylene or EVA (ethylene/vinyl acetate). In one embodiment, organic adhesives are hot-melt adhesives (hotmelts).

In one embodiment of the present invention, tie layer (B) is a layer applied in point, strip or lattice fashion, for example, in the form of rhombuses, rectangles or squares or of a bee honeycomb structure. Polymer layer (C) then comes into contact with flat substrate (A) on the gaps in the tie layer (B).

In one embodiment of the present invention, tie layer (B) is a layer of a cured organic adhesive, for example based on polyvinyl acetate, polyacrylate or in particular polyurethane, preferably on polyurethanes with a glass transition temperature of less than 0° C., determined, for example, by DSC (Differential Scanning Calorimetry) according to DIN 53765.

In this connection, the curing of the organic adhesive can be carried out, for example, thermally, by actinic radiation or by aging.

In another embodiment of the, present invention, tie layer (B) is an adhesive net. In one embodiment, the tie layer (B) is prepared through hot-melt adhesives (hotmelts) based, e.g., on PU, PA, PES, PE or EVA.

Depending on the adhesive and backing materials used, the tie layer (B) can be applied, for example, by scattering, slot die, extrusion, screening or gravure roll.

In a preferred embodiment tie layer (B) is generated by spray application.

In one embodiment of the present invention, tie layer (B) exhibits a thickness in the range from one to a maximum of 100 μm, preferably to 50 μm, particularly preferably to 15 μm.

In another embodiment of the present invention, composite system according to the invention comprises no tie layer (B).

In one embodiment of the present invention, tie layer (B), as also layer (C), can optionally comprise one or more additives, for example one or more flame retardants, stabilizers, such as antioxidants, light stabilizers and/or water repellants or oil repellants.

Suitable flame retardants are, for example, inorganic flame retardants, halogenated organic compounds, organic phosphorus compounds or halogenated organic phosphorus compounds.

Suitable inorganic flame retardants are, for example, phosphates, such as ammonium phosphates, aluminum hydroxides, alumina trihydrates, zinc borates or antimony oxide.

Suitable halogenated organic compounds are, for example, chloroparaffins, polychlorinated biphenyls, hexabromobenzene, polybrominated diphenyl ethers (PBDE) and other bromine compounds, addition products of hexachlorocyclopentadiene, e.g. with cyclooctadiene, tetrabromobisphenol A, tetrabromophthalic anhydride, dibromoneopentyl glycol.

Suitable organic phosphorus compounds are, for example, organic phosphates, phosphites and phosphonates, such as, for example, tricresyl phosphate and tert-butylphenyl diphenyl phosphate.

Suitable halogenated organic phosphorus compounds are, for example, tris(2,3-dibromopropyl) phosphate, tris(2-bromo-4-methylphenyl) phosphate and tris(2-chloroisopropyl) phosphate.

Preferred flame retardants are, for example, polyvinyl chlorides or polyvinylidene chlorides, as well as copolymers of vinylidene chloride with (meth)acrylic acids. Such products are sold, for example, under the trade name Diofan®.

Suitable light stabilizers are, for example, radical traps, such as sterically hindered organic amines (HALS), or peroxide decomposers, for example benzotriazoles, such as 2-(2-hydroxyphenyl)-2H-benzotriazoles (BTZ) or hydroxybenzophenones (BP). Additionally suitable light stabilizers are, for example, (2-hydroxyphenyl)-s-triazines (HPT), oxalanilides or non-pigmentary titanium dioxide.

Suitable light stabilizers are available, for example, under the trade names Irganox®, Irgastab® or Tinuvin®.

Preferred light stabilizers are HALS compounds.

In a preferred embodiment, the at least one tie layer (B) is formed from an aqueous dispersion of an organic adhesive, preferably from a polymer/polyurethane dispersion, which comprises at least one crosslinking agent C.

Preferably, the tie layer (B) comprises at least one organic adhesive based on at least one polyurethane.

In a particularly preferred embodiment of the invention, aqueous polymer/polyurethane dispersions for the preparation of tie layers (B) comprise at least one crosslinking agent C, the at least one crosslinking agent C being at least one polyisocyanate P, the isocyanate groups of which are blocked at ambient temperature with at least one blocking agent BA.

According to the invention, crosslinking agent C comprises no free isocyanate groups at room temperature.

Preferred crosslinking agents C, which can also be described as curing agents, are, for example, polyisocyanates P, in particular aliphatic polyisocyanates P, such as, for, example, isocyanurates, biurets, allophanates or uretdiones based on hexamethylene diisocyanate and/or isophorone diisocyanate. Preferred polyisocyanates P are isocyanurates and/or allophanates of hexamethylene diisoyanate. Especially preferred are isocyanurates of hexamethylene diisocyanate.

In one embodiment, preferred polyisocyanates P comprise a hydrophilic group, through which the polyisocyanates P are more easily dispersible in aqueous systems.

Particularly preferred polyisocyanates P comprise a hydrophilic group which is either anionic or at least one polyether group which is formed at least partially from ethylene oxide.

In one embodiment, suitable crosslinking agents C are added to the aqueous polyurethane dispersion as a 1 to 80% by weight solution in dipropylene glycol dimethyl ether and/or 1,2-propanediol diacetate, preferably as a 30 to 75% by weight solution in dipropylene glycol dimethyl ether and/or 1,2-propanediol diacetate.

Suitable blocking agents BA are, for example, malonic esters, such as diethyl malonate, acetoacetates, such as methyl acetoacetate, pyrazoles, such as 3,5-dimethylpyrazole, lactams, such, as caprolactam or N-methylpyrrolidone, or phenols, such as phenol.

Oximes, such as butanone oxime, are conceivable as blocking agents but are, however, less preferred.

In a particularly preferred embodiment, polyisocyanate crosslinking agents C are added to the aqueous polymer/polyurethane dispersions as a 30 to 75% by weight solution in dipropylene glycol dimethyl ether and/or 1,2-propanediol diacetate.

Composite systems which have been prepared according to the process according to the invention comprise a polymer layer (C) which generally exhibits capillaries which extend over the entire thickness of the polymer layer (C). That is, polymer layer (C) exhibits capillaries which pass right through.

Suitable polymers are all thermoplastic polymers which can be provided in the form preferably of aqueous dispersions. Preferably, they have a glass transition temperature of less than 0° C., determined, for example, by DSC (Differential Scanning Calorimetry) according to DIN 53765. Polymer layer (C) is different from the optionally at least one tie layer (B).

Polymer layer (C) can, for example, be composed essentially of following polymers: polyacrylate, epoxy resins, polyvinyl acetate, polyvinyl chloride, polyvinylidene chloride, polyacrylonitrile, polystyrene, polybutadiene, polyurethane or mixtures thereof. Preferably, polymer layer (C) is essentially composed of polyurethane.

Polystyrene is understood to mean, in the context of this invention, inter alia, all homo- or copolymers which result from polymerization of styrene and/or styrene derivatives. Styrene derivatives are, for example, alkylstyrenes, such as α-methylstyrene, Ortho-, meta- or para-methylstyrene, or para-butylstyrene, in particular para(tert-butyl)styrene, or alkoxystyrenes, such as para-methoxystyrene, para-butoxystyrene or para(tert-butoxy)styrene.

Generally, suitable polystyrenes have an average molar mass Mₙ of 5000 to 1 000 000 g/mol (determined by GPC), preferably 20 000 to 750 000 g/mol, particularly preferably 30 000 to 500 000 g/mol.

In a preferred embodiment, the matrix of the color converter is composed essentially or completely of a homopolymer of styrene or styrene derivatives.

In additional preferred embodiments of the invention, the matrix is essentially or completely composed of a styrene copolymer which in the context of this patent application is likewise regarded as polystyrene. Styrene copolymers can comprise, as additional constituents, for example, butadiene, acrylonitrile, maleic anhydride, vinylcarbazole or esters of acrylic, methacrylic or itaconic acid as monomers. Suitable styrene copolymers generally comprise at least 20% by weight of styrene, preferably at least 40% by weight of styrene and particularly preferably at least 60% by weight of styrene. In another embodiment, they comprise at least 90% by weight of styrene.

Preferred styrene copolymers are styrene/acrylonitrile copolymers (SAN) and acrylonitrile/butadiene/styrene copolymers (ABS), styrene/1,1′-diphenylethene copolymers, acrylic ester/styrene/acrylonitrile copolymers (ASA), styrene/butadiene copolymers (such as SB dispersions) or methyl methacrylate/acrylonitrile/butadiene/styrene copolymers (MABS). An additional preferred polymer is α-methylstyrene/acrylonitrile copolymer (AMSAN).

The styrene homo- or copolymers can, for example, be prepared by radical polymerization, cationic polymerization, anionic polymerization or under the influence of organometallic catalysts (for example, Ziegler-Datta catalysis). This can result in isotactic, syndiotactic or atactic polystyrene or copolymers. They are preferably prepared by radical polymerization. The polymerization can be carried out as suspension polymerization, emulsion polymerization, solution polymerization or bulk polymerization.

Suitable polyacrylates generally have a molecular weight 5000 to 000 000 g mol.

Suitable polyacrylates can preferably be prepared by radical (co)polymerization of the corresponding comonomers, preferably by radical emulsion copolymerization, which in the context of the present invention is also described for simplicity as radical emulsion polymerization. The preparation of polyacrylate dispersions by solution copolymerization is also possible.

This is known, for example, from US-A 5 221 284 and US-A 5 376 459.

Particularly preferred are polyacrylates which are available by radical copolymerization from at least one of the following monomers.
1) Acrylic acid or methacrylic acid and the derivatives thereof of the formula CH₂═CR¹-CO—OR², in which R¹ represents hydrogen or methyl and R² represents a hydrocarbon radical with from 1 to 40 carbon atoms which can also be substituted by fluorine, hydroxyl, C₁₋₄-alkylamino, C₁₋₄ alkyloxy, carbonyl groups and also polyether groups; preferably, R² has from 1 to 10 carbon atoms; particularly preferably, R² is methyl, ethyl, propyl, isopropyl, butyl, tert-butyl, hexyl or ethylhexyl;
(2) acrylamide, methacrylamide or the derivatives thereof,
(3) styrene and substituted styrenes, such as α-methylstyrene,
(4) acrylonitrile,
(5) vinyl esters, such as vinyl acetate or vinyl propionate, and/or
(6) unsaturated dicarboxylic acids, such as crotonic acid, itaconic acid or maleic anhydride,
(7) olefins, such as ethylene.

In a preferred embodiment, suitable polyacrylates do not comprise any comonomers copolymerized which, under the action of temperatures in the range from 100 to 250° C., can split off formaldehyde, such as, for example, N-methylol(meth)acrylamide.

In another embodiment, suitable polyacrylates comprise comonomers copolymerized which, under the action of temperatures in the range from 100 to 250° C., can split off formaldehyde, such as, for example, N-methylol(meth)acrylamide.

Suitable polyacrylates are preferably obtained by radical copolymerization of at least two comonomers, at least one of which is chosen from (meth)acrylic acid and (meth)acrylates, for example C₁-C₂₀-alkyl (meth)acrylates, preferably C₁-C₁₀-alkyl (meth)acrylates, and which preferably make up at least 50% by weight of polymer layer (C).

In one embodiment of the present invention, suitable polyacrylates are chosen from copolymers which comprise copolymerized as comonomer (meth)acrylic acid, comonomer with an epoxide group in the molecule, such as, for example, glycidyl (meth)acrylate, ω-hydroxy-C₂-C₁₀-alkyl (meth)acrylate or (meth)acrylic ester of alcohols of the general formula I

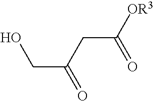

in which

R³ is chosen from branched and preferably unbranched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl or n-decyl, particularly preferably unbranched C₁-C₄-alkyl such as methyl, ethyl, n-propyl and n-butyl.

Mention may additionally be made, as poly(meth)acrylates within the meaning of the present invention, of copolymers of one or more C₁-C₁₀-alkyl (meth)acrylates which, for example, can comprise, copolymerized, (meth)acrylic acid, glycidyl (meth)acrylates or C₂-C₁₀-hydroxyalkyl (meth)acrylates and optionally one or more additional comonomers. Mention may be made, as additional comonomers, for example, of vinylaromatic compounds, such as α-methylstyrene, para-methyistyrene and in particular styrene. furthermore (meth)acrylamide, vinyl chloride or (meth)acrylonitrile.

Examples of particularly suitable C₁-C₁₀-alkyl (meth)acrylates are methyl (meth)acrylate, ethyl (meth)acrylate, n-propyl (meth)acrylate, isopropyl (meth)acrylate, n-butyl (meth)acrylate, n-hexyl (meth)acrylate, 2-ethylhexyl (meth)acrylate or n-decyl(meth)-acrylate.

Examples of particularly suitable ω-hydroxy-C₂-C₁₀-alkylene (meth)acrylates are in particular ω-hydroxy-C₂-C₁₀-alkyl (meth)acrylates, such as 6-hydroxyhexyl (meth)acrylate, 4-hydroxybutyl (meth)acrylate, 3-hydroxypropyl (meth)acrylate and in particular 2-hydroxyethyl (meth)acrylate.

In a preferred alternative form, suitable polyacrylates are chosen from those poly(meth)acrylates which comprise, copolymerized, copolymers of one or more C₁-C₁₀-alkyl (meth)acrylates and (meth)acrylic acid and at least one comonomer chosen from glycidyl (meth)acrylate and C₂-C₁₀-hydroxyalkyl (meth)acrylate, at the same time optionally one or more additional comonomers.

If polyacrylates comprising, copolymerized, (meth)acrylic acid are used, the carboxyl groups of the copolymerized (meth)acrylic acid can be present in the free form or in the completely or partially neutralized form, for example in the form completely or partially neutralized with alkali, with ammonia or with amine. Particularly suitable amines are, for example, tertiary amines, e.g. (C₁-C₄-alkyl)₃N, in particular triethylamine, and alkanolamines, such as, for example. ethanolamine, diethanolamine, triethanolamine, N-methylethanolamine. N,N-dimethylethanolamine and N-(n-butyl)ethanolamine.

Suitable polybutadienes are generally copolymers of butadiene with acrylonitrile and/or styrene and/or (meth)acrylic esters and/or optionally other unsaturated monomers. Suitable polybutadiene dispersions can be crosslinked by the application with metal oxides, such as zinc oxide.

Suitable polyvinylidene chlorides are generally copolymers of vinylidene chloride with (meth)acrylic esters. Such products are, for example, sold under the trade name Diofan®.

Suitable polyvinyl chlorides (PVC) are preferably obtained by homopolymerization of vinyl chloride. In another embodiment, suitable polyvinyl chlorides are obtained by copolymerization of vinyl chloride with other monomers.

Suitable polyvinyl chlorides can, for example, be obtained by emulsion polymerization or suspension polymerization.

Suitable polyvinyl chloride dispersions are, for example, commercially available under the trade names SolVin® or Diofan®.

Epoxy resins are prepared either by catalytic polymerization of epoxides (oxiranes) or by reaction of epoxides, for example epichlorohydrin, with diols, for example with bisphenols, such as bisphenol A or bisphenol F.

Suitable epoxy resins can, for example, be liquid or solid resins based on bisphenol A or F. Suitable liquid epoxy resins, such as bisphenol·A diglycidyl ethers, typically have a molecular weight of 200 to 1000 g/mol, preferably 300 to 500 g/mol, particularly preferably approximately 380 g/mol. Suitable epoxy resins are frequently bifunctional. A molar mass of 380 g/mol then corresponds to an Epoxy-Equivalent-Weight (EEW) of 190 g/mol. In aqueous systems, the inexpensive water-insoluble liquid resins can be used without further additives. In these cases, the curing agent used acts as emulsifier.

Suitable hydrophobic solid resins frequently have a molecular weight of 500 to 5000 g/mol, preferably 700 to 3000 g/mol, particularly preferably 900 to 2000 g/mol and particularly preferably 1000 to 1500 g/mol. In untreated form, they are not compatible with water-based systems. Dispersions of such resins can be prepared with the assistance of reactive nonionic emulsifiers. Stable emulsions generally have an average particle diameter of less than one micrometer.

The less preferred solvent-based 2-component epoxy resins based on bisphenol A diglycidyl ethers can, for example, be cured with amines and amine derivatives or mercaptans. The amine curing agents used for this can, for example, be low molecular weight cycloaliphatic amines, such as meta-xylenediamine (MXDA), isophoronediamine (IPDA), diethylenetriamine (DETA), triethylenetetraamine (TETA), polymeric polyaminoamides or water-soluble emulsifying amine-comprising polymers.

Suitable aqueous 2-component epoxy resin systems can, for example, be obtained by, emulsifying liquid epoxy resins with suitable surface-active compounds and by modifying curing agents, such as, for example, polyamidoamine curing agents, by addition of emulsifiers and protonating to the effect that these became water soluble.

Aqueous curing agents can consist in the molecular composition of a balanced ratio of hydrophobic and hydrophilic elements which make possible self emulsification of liquid resins. The abovementioned amines, which, depending on structure, are more hydrophilic (e.g., TETA) or hydrophobic (e.g., IPDA), can be used for this as a reactant and later crosslinking center. Typical hydrophilicity elements of a curing agent structure are, for example, nonionic polyethylene/propylene glycol elements having a different molecular weight; bisphenol A diglycidyl ether compounds are frequently used as hydrophobic component. Curing agents with many different properties can be prepared by carefully constructing the molecular structure from these or similar building blocks. Typical self-emulsifying epoxy curing agents are, for example, available under the trade names WEX and Waterpoxy® from BASF.

In the field of aqueous epoxy resin systems, two different systems, which are also described as type I and type II systems, are suitable in particular. Type I systems are based on liquid resin systems with an EEW<250. Type II systems are based on solid resin emulsions with an EEW>250.

In type I systems, the curing agent used, in addition to its role as curing agent, also acts as emulsifier for the liquid resin. The result of this is that, in such systems, the emulsion particle comprises both resin and curing agent already shortly after the mixing of resin and curing agent. In addition to that, a certain proportion of the curing agent can also be present in the aqueous phase. The spatial proximity of resin and curing agent in the same emulsion particle generally results in rapid curing with correspondingly short potlife (<3 h). One advantage of type I systems is that they can often be formulated completely VOC-free. Because of the short spacings of the crosslinking sites and of the rigid polymer backbone, the cured films have a high hardness with an often low flexibility and high chemical resistance.

Type II systems are typically based on solid resin emulsions with an EEW>250 and a solids content of 45-62%. Since the solid resin already exists as emulsion, the use of self-emulsifying curing agents as in type I systems is not absolutely necessary but furthermore possible. Accordingly, a clearly broader pallet of useful curing agents is available for type II systems. For example, non-self-emulsifying curing agents, such as amine-based curing agents, for example Waterpoxy® 801, can be used here; however, self-emulsifying curing agents, such as, e.g., Waterpoxy® 751, can also be used.

In contrast to type I systems, the emulsified relatively high molecular weight solid resins of the type II systems require coalescence agents in order for good film formation to be guaranteed. Accordingly, they have, in contrast to type I systems, for the most part a VOC content of 50-150 g/l. It is likewise possible to use VOC-free solid resin emulsions.

Polyurethanes (PU) are generally known and commercially available and generally consist of a soft phase of relatively high molecular weight polyhydroxyl compounds, e.g. of polycarbonate, polyester or polyether segments, and of a urethane hard phase formed of low molecular weight chain extenders and di- or polyisocyanates.

Processes for the preparation of polyurethanes (PU) are generally known. Generally, polyurethanes (PU) are prepared by reaction of
(i) isocyanates, preferably diisocyanates, with
(ii) compounds which react with isocyanates, usually with a molecular weight (M_{w}) of 500 to 10 000 g/mol, preferably 500 to 5000 g/mol, particularly preferably 800 to 3000 g/mol, and
(iii) chain extenders with a molecular weight of 50 to 499 g/mol, optionally in the presence of
(iv) catalysts
(v) and/or normal additives.

In the following, the starting components and processes for the preparation of the preferred polyurethanes (PU) are to be explained by way of example. The components (i), (ii), (iii), and also optionally (iv) and/or (v), customarily used in the preparation of the polyurethanes (PU) are to be described below by way of example:

Use may be made, as isocyanates (i), of generally known aliphatic, cycloaliphatic, araliphatic and/or aromatic isocyanates, for example tri-, tetra-, penta-, hexa-, hepta- and/or octamethylene diisocyanate, 2-methyl-1,5-pentamethylene diisocyanate, 2-ethyl-1,4-butylene diisocyanate, 1,5-pentamethylene diisocyanate, 1,4-butylene diisocyanate, 1-isocyanato-3,3,5-trimethyl-5-(isocyanatomethyl)cyclohexane (isophorone diisocyanate, IPDI), 1,4- and/or 1,3-bis(isocyanatomethyl)cyclohexane (HXDI), 1,4-cyclohexane diisocyanate, 1-methyl-2,4-and/or -2,6-cyclohexane diisocyanate and/or 4,4′-, 2,4′- and 2,2′-dicyclohexylmethane diisocyanate, 2,2′-, 2,4′- and/or 4,4′-diphenylmethane diisocyanate (MDI), 1,5-naphthylene diisocyanate (NDI), 2,4- and/or 2,6-toluylene diisocyanate (TDI), diphenylmethane diisocyanate, 3,3′-dimethyldiphenyl diisocyanate, 1,2-diphenylethane diisocyanate and/or phenylene diisocyanate. 4,4′-MDI is preferably used. Aliphatic diisocyanates, in particular hexamethylene diisocyanate (HDI), are additionally preferred and aromatic diisocyanates, such as 2,2′-, 2,4′-and/or 4,4′-diphenylmethane diisocyanate (MDI) and mixtures of the abovementioned isomers are especially preferred.

Use may be made, as compounds which react with isocyanates (ii), of the generally known compounds which react with isocyanates, for example polyesterols, polyetherols and/or polycarbonate diols, which are normally also combined under the term “polyols”, with molecular weights (M_{w}) in the range from 500 to 8000 g/mol, preferably 600 to 6000 g/mol and in particular 800 to 3000 g/mol, and preferably with an average functionality with regard to isocyanates of 1.8 to 2.3, preferably 1.9 to 2.2 and in particular 2. Use is preferably made of polyether polyols, for example those based on generally known starting substances and customary alkylene oxides, for example ethylene oxide, 1,2-propylene oxide and/or 1,2-butylene oxide, preferably polyetherols based on polyoxytetramethylene (poly-THF), 1,2-propylene oxide and ethylene oxide. Polyetherols exhibit the advantage that they have a greater stability to hydrolysis than polyesterols and are preferred as component (ii), in particular for the preparation of soft polyurethanes, polyurethane (PU1).

Mention may be made, as polycarbonate diols, of in particular aliphatic polycarbonate diols, for example 1,4-butanediol polycarbonate and 1,6-hexanediol polycarbonate.

Mention may be made, as polyester diols, of those which can be prepared by polycondensation of at least one primary diol, preferably at least one primary aliphatic diol, for example ethylene glycol, 1,4-butanediol, 1,6-hexanediol, neopentyl glycol or particularly preferably 1,4-di(hydroxymethyl)cyclohexane (as isomer mixture) or mixtures of at least two of the abovementioned diols, on the one hand, and at least one, preferably at least two, dicarboxylic acids or their anhydrides, on the other hand. Preferred dicarboxylic acids are aliphatic dicarboxylic acids, such as adipic acid, glutaric acid or succinic acid, and aromatic dicarboxylic acids, such as, for example, phthalic acid and in particular isophthalic acid.

Polyetherols are preferably prepared by addition of alkylene oxides, in particular ethylene oxide, propylene oxide and mixtures thereof, to diols, such as, for example, ethylene glycol, 1,2-propylene glycol, 1,2-butylene glycol, 1,4-butanediol or 1,3-propanediol, or to triols, such as, for example, glycerol, in the presence of highly active catalysts. Such highly active catalysts are, for example, cesium hydroxide and double metal cyanide catalysts, also described as DMC catalysts. A frequently used DMC catalyst is zinc hexacyanocobaltate. The DMC catalyst can be left in the polyetherol after the reaction; preferably, it is removed, for example by sedimentation or filtration.

Mixtures of different polyols can also be used instead of one polyol.

In order to improve the dispersability, use may also be made, as compounds which react with isocyanates (ii), of a proportion of one or more dials or diamines with a carboxylic acid group or sulfonic acid group (b′), in particular alkali metal or ammonium salts of 1,1-dimethylolbutanoic acid, 1,1-dimethylolpropionic acid or

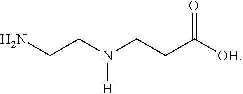

Use is made, as chain extenders (iii), of aliphatic, araliphatic, aromatic and/or cycloaliphatic compounds with a molecular weight of 50 to 499 g/mol and at least two functional groups, preferably compounds with exactly two functional groups per molecule, which are known per se, for example diamines and/or alkanediols with from 2 to 10 atoms in the alkylene radical, in particular 1,3-propanediol, 1,4-butanediol, 1,6-hexanediol and/or di-, tri-, tetra-, penta-, hexa-, hepta-, octa-, nona:- and/or decaalkylene glycols with from 3 to 8 carbon atoms per molecule, preferably corresponding oligo- and/or polypropylene glycols, it also being possible to use mixtures of chain extenders (iii).

The, components (i) to (iii) are particularly preferably difunctional compounds, i.e. diisocyanates (i), difunctional polyols, preferably polyetherols (ii) and difunctional chain extenders, preferably diols.

Suitable catalysts (iv), which in particular accelerate the reaction between the NCO groups of the diisocyanates (i) and the hydroxyl groups of the components (ii) and (iii), are tertiary amines, such as, e.g., triethylamine, dimethylcyclohexylamine, N-methylmorpholine, N,N′-dimethylpiperazine, 2-(dimethylaminoethoxy)ethanol, diazabicyclo[2.2.2)octane (“DABCO”) and similar tertiary amines, as well as in particular organic metal compounds, such as titanic acid esters, iron compounds, such as, e.g., iron(III) acetylacetonate, tin compounds, e.g. tin diacetate, tin dioctoate, tin dilaurate or the dialkyltin salts of aliphatic carboxylic acids, such as dibutyltin diacetate, dibutyltin dilaurate or the like, which are known per se. The catalysts are normally used in amounts of 0.0001 to 0.1 parts by weight per 100 parts by weight of component (ii).

In addition to catalysts (iv), auxiliaries and/or additives (v) can be added to the components (i) to (iii). Mention may be made, for example, of blowing agents, antiblocking agents, surface-active substances, fillers, for example fillers based on nanoparticles, in particular fillers based on CaCO_{3,} furthermore, nucleating agents, slip agents, dyes and pigments, antioxidants, e.g. against hydrolysis, light, heat or discoloration, inorganic and/or organic fillers, reinforcing agents and plasticizers, or metal deactivators. In a preferred embodiment, the component (v) also includes hydrolysis stabilizers, such as, for example, polymeric and low molecular weight carbodiimides. The soft polyurethane preferably comprises triazole and/or triazole derivatives and antioxidants in an amount of 0.1 to 5% by weight, based on the total weight of the relevant soft polyurethane. Suitable as antioxidants are generally substances which hinder or prevent undesirable oxidative processes in the plastic to be protected. Generally, antioxidants are commercially available. Examples of antioxidants are sterically hindered phenols, aromatic amines, thiosynergists, organophosphorus compounds of Trivalent Phosphors, and Hindered Amine Light Stabilizers. Examples of sterically hindered phenols are found in Plastics Additive Handbook, 5th edition, H. Zweifel, ed., Hanser Publishers, Munich, 2001 ([1]), pp. 98-107 and p. 116-p. 121. Examples of aromatic amines are found in [1] pp. 107-108. Examples of thiosynergists are given in [1], pp. 104-105 and pp. 112-113. Examples of phosphites are found in [1], pp. 109-112. Examples of Hindered Amine Light Stabilizers are given in [1], pp. 123-136. Phenolic antioxidants are preferably suitable for use in the antioxidant mixture. In a preferred embodiment, the antioxidants, in particular the phenolic antioxidants, exhibit a molar mass of greater than 350 g/mol, particularly preferably of greater than 700 g/mol, and with a maximum molar mass (M_{w}) up to a maximum of 10 000 g/mol, preferably up to a maximum of 3000 g/mol. Moreover, they preferably have a melting point of at most 180° C. Furthermore, use is preferably made of antioxidants which are amorphous or liquid. Likewise, mixtures of two or more antioxidants can also be used as component (v).

In addition to the components (i), (ii) and (iii) and optionally (iv) and (v) mentioned, use may also be made of chain regulators (chain terminators), usually with a molecular weight of 31 to 3000 g/mol. Such chain regulators are compounds which exhibit only one functional group which reacts with isocyanates, such as, e.g., monofunctional alcohols, monofunctional amines and/or monofunctional polyols. Flow behavior, in particular with soft polyurethanes, can be selectively adjusted through such chain regulators. Chain regulators can generally be used in an amount of 0 to 5 parts by weight, preferably 0.1 to 1 part by weight, based on 100 parts by weight of the component (ii), and fall under the definition of the component (iii).

In addition to the components (0, (ii) and (iii) and optionally (iv) and (v) mentioned, crosslinking agents with two or more groups which react with isocyanate can also be used toward the end of the synthesis reaction, for example hydrazine hydrate.

The components (ii) and (iii) can be chosen in relatively broad molar ratios in order to adjust the hardness of polyurethane (PU). Molar ratios of component (ii) to total chain extenders (iii) to be used of 10:1 to 1:10, in particular from 1:1 to 1:4, have proved to be worthwhile, the hardness of the soft polyurethanes increasing with increasing content of (iii). The reaction for the preparation of polyurethane (PU) can be carried out at an index of 0.8 to 1.4:1, preferably at an index of 0.9 to 1.2:1, particularly preferably at an index of 1.05 to 1.2:1. The index is defined by the ratio of the total isocyanate groups of the component (i) used in the reaction to the groups which react with isocyanates, i.e. the active hydrogens, of the components (ii) and optionally (iii) and optionally monofunctional components which react with isocyanates as chain terminators, such as, e.g., monoalcohols.

The preparation of polyurethane (PU) can, according to processes known per se, be carried out continuously, for example according to the one-shot or the prepolymer process, or batchwise, according to the prepolymer operation known per se. In these processes, the components (i), (ii), (iii) and optionally (iv) and/or (v) to be reacted can be mixed with one another successively or simultaneously, the reaction beginning immediately.

Polyurethane (PU) can be dispersed in water according to processes known per se, for example by dissolving polyurethane (PU) in acetone or preparing polyurethane as a solution in acetone, adding water and then removing the acetone, for example by distillation. In an alternative form, polyurethane (PU) is prepared as a solution in N-methylpyrrolidone or N-ethylpyrrolidone, water is added and the N-methylpyrrolidone or N-ethylpyrrolidone is removed.

In one embodiment of the present invention, aqueous dispersions according to the invention comprise two different polyurethanes, polyurethane (PU1) and polyurethane (PU2), of which polyurethane (PU1) is a “soft” polyurethane, which is constructed as described above as polyurethane (PU), and at least one hard polyurethane (PU2).

Hard polyurethane (PU2) can in principle be prepared analogously to soft polyurethane (PU1); however, other compounds (ii) which react with isocyanates or other mixtures of compounds (ii) which react with isocyanates are chosen, also described in the context of the present invention as compounds (ii-2) which react with isocyanates or in short compounds (ii-2).

Examples of compounds (ii-2) are in particular 1,4-butanediol, 1,6-hexanediol and neopentyl glycol, either in a mixture with one another or in a mixture with polyethylene glycol.

In an alternative form of the present invention, mixtures of diisocyanates, for example mixtures of HDI and IPDI, are this time chosen as diisocyanate (i) for polyurethane (PU2), larger proportions of IPDI being chosen for the preparation of hard polyurethane (PU2) than for the preparation of soft polyurethane (PU1).

In one embodiment of the present invention, polyurethane (PU2) exhibits a Shore A hardness in the range from over 60 up to at most 100, the Shore A hardness having been determined according to DIN 53505 after 3 s.

In one embodiment of the present invention, polyurethane (PU) exhibits an average particle diameter in the range from 100 to 300 nm, preferably 120 to 150 nm, determined by laser light scattering.

In one embodiment of the present invention, soft polyurethane (PU1) exhibits an average particle diameter in the range from 100 to 300 nm, preferably 120 to 150 nm, determined by laser light scattering.

In one embodiment of the present invention, polyurethane (PU2) exhibits an average particle diameter in the range from 100 to 300 nm, preferably 120 to 150 nm, determined by laser light scattering.

Polymer layer (C) is preferably a polyurethane layer, a PVC layer, a layer of an epoxy resin, a polyacrylate layer or a polybutadiene layer, particularly preferably a polyurethane layer. Polymer layer (C) is particularly preferably a polyurethane layer.

In one embodiment, of the present invention, polymer layer (C) exhibits an average thickness in the range from 15 to 300 μm, preferably from 20 to 150 μm, particularly preferably from 25 to 80 μm.

In one embodiment of the present invention, polymer layer (C) exhibits, on average, at least 100, preferably at least 250, and particularly preferably at least 1000 capillaries per 100 cm².

In one embodiment of the present invention, the capillaries exhibit an average diameter in the range from 0.005 to 0.05 mm, preferably from 0.009 to 0.03 mm.

In one embodiment of the present invention, the capillaries are evenly distributed over polymer layer (C). In a preferred embodiment of the present invention, the capillaries, however, are unevenly distributed over the polymer layer (C).

In one embodiment of the present invention, the capillaries are essentially curved. In another embodiment of the present invention, the capillaries exhibit an essentially linear course.

The capillaries bestow permeability to air and to water vapor on the polymer layer (C), without perforation being necessary. In one embodiment of the present invention, the permeability to water vapor of the polymer layer (C) can be more than 1.5 g/cm²·h, measured according to DIN 53333. It is thus possible, for example, for liquids comprising an active compound to be able to migrate through the polymer layer (C).

In one embodiment of the present invention, polymer layer (C) even exhibits, in addition to the capillaries, pores which do not extend over the total thickness of the polymer layer (C).

In one embodiment, polymer layer (C), in particular polyurethane layer (C), exhibits a pattern. The pattern can be any pattern and, for example, can reproduce the pattern of a leather or of a wood surface. In one embodiment of the present invention, the pattern can reproduce a nubuck leather.

In one embodiment of the present invention, polymer layer (C), in particular polyurethane layer (C), exhibits a velvety appearance.

In one embodiment of the present invention, the pattern can correspond to a velvet surface, for example with small crinite features with an average length of 20 to 500 μm, preferably 30 to 200 μm and, particularly preferably 60 to 100 μm. The small crinite features can, for example, exhibit a circular diameter. In a special embodiment of the present invention, the small crinite features have a conical shape.

In one embodiment of the present invention, polymer layer (C), in particular polyurethane layer (C), exhibits small crinite features which are arranged at an average distance of 50 to 350 μm, preferably 100 to 250 μm, from one another.

In case the polymer layer (C), in particular polyurethane layer (C), exhibits small crinite features, the statements refer, with regard to the average thickness, to the polyurethane layer (C) without the small crinite features.

In other embodiments, polymer layer (C), in particular polyurethane layer (C), exhibits text, logos or pictures.

In one embodiment polymer layer (C), in particular polyurethane layer (C), exhibits complicated pictures, as are described in WO 2012/072740.

In a preferred embodiment, polymer layer (C), in particular polyurethane layer (C), is formed from an aqueous polymer dispersion, preferably polyurethane dispersion, which comprises at least one crosslinking agent C, the at least one crosslinking agent C being at least one polyisocyanate P which is blocked with at least one blocking agent BA.

In a particularly preferred embodiment of the invention, aqueous polymer/polyurethane dispersions for the preparation of tie layers (B) and/or polymer layer (C), in particular polyurethane layer (C), comprise from 0.1 to 5% by weight of dipropylene glycol dimethyl ether and/or 1,2-propanediol diacetate.

In a particularly preferred embodiment, suitable crosslinking agents C are added to the aqueous polymer/polyurethane dispersions as a 1 to 80% by weight solution in dipropylene glycol dimethyl ether and/or 1,2-propanediol diacetate, preferably as a 30 to 75% by weight solution in dipropylene glycol dimethyl ether and/or 1,2-propanediol diacetate.

In a particularly preferred embodiment, polyisocyanate crosslinking agents C are added to the aqueous polymer/polyurethane dispersions as a 30 to 75% by weight solution in dipropylene glycol dimethyl ether and/or 1,2-propanediol diacetate.

According to the invention, at least one of the layers (B) and (C) comprises least one polyisocyanate P blocked with blocking agent BA. In a preferred embodiment, both layer (B) and layer (C) comprise polyisocyanate P blocked with blocking agent BA. Suitable, polyisocyanates P and blocking agents BA are described further above.

According to the invention, crosslinking agent C and polyisocyanate P comprises no free isocyanate groups at ambient temperature

The polyisocyanates P blocked with blocking agent BA present in the layers (B) and (C) can be identical or different. Preferably, layers (B) and (C) comprise the same polyisocyanates P blocked with blocking agent BA.

The process according to the invention is usually carried out so that, using a mold, a polymer layer (C) is formed (stage (a)), optionally at least one organic adhesive is applied all over or partially to backing material (A) and/or to polymer layer (C) (stage (b)) and then polymer layer (C) is bonded to backing material (A) in point, strip or two-dimensional fashion (stage (c)), polymer layer (C) and/or the optionally at least one tie layer (B) being prepared from aqueous polymer dispersions which comprise at least one crosslinking agent C, the at least one crosslinking agent C being at least one polyisocyanate P, the isocyanate groups of which are blocked at ambient temperature with at least one blocking agent BA.

The mold is preferably a silicone mold. Silicone molds are understood to mean, in the context of the present invention, those molds in the preparation of which at least one binder is used which exhibits at least one, preferably at least three, O—Si(R¹R²)—O— groups per molecule. In this connection, R¹ and—if present—R² are different or, preferably, identical and are chosen from organic groups and preferably C₁-C₆-alkyl, in particular methyl.

In one embodiment of the present invention, the silicone mold is a silicone mold structured using laser engraving

In another embodiment, the mold is a mold made of ethylene/propylene rubber (EPM) or ethylene/propylene/diene rubber (EPDM).

In one embodiment of the present invention, the mold made of EPM or EPDM is a mold structured using laser engraving.

Stage (a) can be carried out as follows.

An aqueous polymer dispersion is applied to a mold which is preheated and the water is allowed to evaporate.

The application of the aqueous polymer dispersion to the mold can be carried out according to methods known per se, in particular by spraying, for example with a spray gun.

The mold exhibits a pattern, also known as structuring, which is produced, for example, by laser engraving or by molding.

If it is desired to structure the mold using laser engraving, it is preferable, before the laser engraving, to strengthen the laser-engraveable layer by heating (thermochemically), by irradiating with UV light (photochemically) or by irradiating with high energy radiation (actinically) or any combination thereof.

Subsequently, the laser-engraveable layer or the layer composite is applied to a cylindrical (temporary) backing, for example made of plastic, glass fiber-reinforced plastic, metal or foam, for example using adhesive tape, negative pressure, clamping devices or magnetic force, and engraved as described above. Alternatively, the plane layer or the layer composite can also be engraved as described above. Optionally, during the laser engraving operation, the laser-engraveable layer is washed using a rotary cylindrical washer or a continuous washer with a cleaning agent for removing engraving residues.

In the manner described, the mold can be prepared as a negative mold or as a positive mold.

In a first alternative form, the mold exhibits a negative structure, so that the coating which can be bonded to film (A) can be obtained directly by application of a liquid plastic material to the surface of the mold and subsequent solidification of the polymer.

In a second alternative form, the mold exhibits a positive structure, so that a negative mold is first prepared from the laser-structured positive mold by molding. The coating which can be bonded to a flat backing can subsequently be obtained from this negative mold by application of a liquid plastic material to the surface of the negative mold and subsequent solidification of the plastic material.

Preferably, structure elements having dimensions in the range from 10 to 500 μm are engraved in the mold. The structure elements can be formed as elevations or depressions. The structure elements preferably have a simple geometric shape and are, for example, circles, ellipses, squares, rhombuses, triangles and stars. The structure elements can form a regular or irregular screen. Examples are a classical dot screen or a stochastic screen, for example a frequency-modulated screen.

In one embodiment of the present invention, wells are incorporated in the mold in the, structuring of the mold using a laser, which wells exhibit an average depth in the range from 50 to 250 μm and a center-to-center separation in the range from 50 to 250 μm.

For example, the mold can be engraved so that it exhibits “wells” (depressions) which exhibit a diameter in the range from 10 to 500 μm on the surface of the mold. The diameter on the surface of the mold is preferably from 20 to 250 μm and particularly preferably from 30 to 150 μm. The separation of the wells can, for example, be from 10 to 500 μm, preferably from 20 to 200 μm, particularly preferably up to 80 μm.

In one embodiment of the present invention, the mold preferably exhibits, in addition to a coarse surface structure, also a fine surface structure. Both coarse and fine structure can be produced by laser engraving. The fine structure can, for example, be a microroughness with a roughness amplitude in the range from 1 to 30 μm and a roughness frequency of 0.5 to 30 μm. The dimensions of the microroughness are preferably in the range from 1 to 20 μm, particularly preferably from 2 to 15 μm and particularly preferably from 3 to 10 μm.

IR lasers are suitable in particular for laser engraving. However, it is also possible to use lasers with shorter wavelengths, provided that the laser exhibits a satisfactory intensity. For example, a frequency-doubled (532 nm) or frequency-tripled (355 nm) Nd-YAG laser can be used, or also an excimer laser (e.g. 248 nm). A CO₂ laser with a wavelength of 10640 nm can, for example, be used for the laser engraving. Lasers with a wavelength of 600 to 2000 nm are particularly preferably used. For example, Nd-YAG lasers (1064 nm), IR diode lasers or solid-state lasers can be used. Nd1YAG lasers are particularly preferred. The image information to be engraved is transferred directly from the layout computer system to the laser apparatus. The laser can be operated either continuously or in pulsed mode.

As a rule, the mold obtained can be used directly after it has been prepared. If desired, the mold obtained can still be cleaned subsequently. Layer constituents which have been loosened but possibly still not completely removed from the surface are removed by such a cleaning stage.

As a rule, simple treatment with water, water/surfactant alcohols or inert organic cleaning agents, which are preferably low-swelling, is sufficient.

In an additional stage, an aqueous formulation of polymer is applied to the mold. Application can preferably be carried out by spraying. The mold should be heated, if the formulation of polymer is applied, for example to temperatures of at least 80° C., preferably at least 90° C. The water from the aqueous formulation of polymer evaporates and forms the capillaries in the solidifying polymer layer.

Aqueous is understood to mean, in connection with the polymer dispersion, that it comprises water but less than 5% by weight, based on the dispersion, preferably less than 1% by weight, of organic solvent. Particularly preferably, no volatile organic solvent can be detected. Volatile organic solvents are understood to mean, in the context of the present invention, those organic solvents which, at standard pressure, exhibit a boiling point of up to 200° C.

In one embodiment of the present invention, aqueous polymer dispersion comprises at least one additive chosen from pigments, delustrants, light stabilizers, flame retardants, antioxidants, antistatics, antisoiling agents, antisqueak agents, thickening agents, in particular thickening agents based on polyurethanes, water repellants, oil repellants and hollow microspheres. In one embodiment, of the, present invention, aqueous polymer dispersion comprises in total, up to 20% by weight of additives.

Aqueous polymer dispersion can additionally comprise one or more organic solvents. Suitable organic solvents are, for example, alcohols, such as ethanol or isopropanol and in particular glycols, diglycols, triglycols or tetraglycols and glycols, diglycols, triglycols or tetraglycols dialkoxylated or preferably monoalkoxylated with C₁-C₄-alcohols. Examples of suitable organic solvents are ethylene glycol, propylene glycol, butylene glycol, diethylene glycol, triethylene glycol, tetraethylene glycol, dipropylene glycol, 1,2-dimethoxyethane, methyl triethylene glycol (“methyl triglycol”) and triethylene glycol n-butyl ether (“butyl triglycol”).

In one embodiment of the invention, aqueous polymers, in particular polyurethane dispersions, do not comprise any propylene carbonate.

In a preferred embodiment, polymer layer (C) is formed from an aqueous polymer dispersion, preferably polyurethane dispersion, which comprises at least one crosslinking agent C, the at least one crosslinking agent C being at least one polyisocyanate P which is blocked with at least one blocking agent BA, as are defined above.

In one embodiment of the invention, aqueous polymer/polyurethane dispersions for the preparation of tie layers (B) and/or polymer layer (C) comprise from 0.1 to 5% by weight of dipropylene glycol dimethyl ether and/or 1,2-propanediol diacetate.

In a particularly preferred embodiment, suitable crosslinking agents C are added, as 1 to 80% by weight solution in dipropylene glycol dimethyl ether and/or 1,2-propanediol diacetate, preferably as 30 to 75% by weight solution in dipropylene glycol dimethyl ether and/or 1,2-propanediol diacetate, to the aqueous polymer/polyurethane dispersions for the preparation of the at least one polymer layer (C).

In a particularly preferred embodiment, polyisocyanate crosslinking agents C are added, as 30 to 75% by weight solution in dipropylene glycol dimethyl ether and/or 1,2-propanediol diacetate, to the aqueous polymer/polyurethane dispersions for the preparation of at least one polymer layer (C).

After the curing of the polymer layer (C), it is separated from the mold, for example by stripping, and a polymer film is obtained which forms, in the multilayered composite system according to the invention, the polymer layer (C).

In a preferred embodiment of the present invention, the mold can also be allowed to act as protective layer and it can be removed only after the preparation of the actual multilayered composite system.

Stage (b) can be carried out as follows.

An aqueous dispersion of at least one organic adhesive is applied to, polymer film (C) and/or backing (A) and the water is allowed to completely or partially, preferably completely, evaporate. The aqueous dispersion of at least one organic adhesive is generally a polymer dispersion, preferably a polyurethane dispersion.

The application of aqueous adhesive dispersion to the mold can be carried out according to methods known per se, in particular by spraying, for example with a spray gun, knife coating or painting.

In one embodiment of the present invention, aqueous dispersion of at least one organic adhesive comprises at least one additive chosen from pigments, delustrants, light stabilizers, flame retardants, antioxidants, antistatics, antisoiling agents, antisqueak agents, thickening agents, in particular thickening agents based on polyurethanes, and hollow microsphere.

In one embodiment of the present invention, the aqueous dispersion of at least one organic adhesive comprises in total up to 20% by weight of additives.

The aqueous dispersion of at least one organic adhesive can additionally comprise one or more organic solvents. Suitable organic solvents are, for example, alcohols, such as ethanol or isopropanol and in particular glycols, diglycols, triglycols or tetraglycols and glycols, diglycols, triglycols or tetraglycols dialkoxylated or preferably monoalkoxylated with C₁-C₄-alcohols. Examples of suitable organic solvents are ethylene glycol, propylene glycol, butylene glycol, diethylene glycol, triethylene glycol, tetraethylene glycol dipropylene 1,2-dimethoxyethane, methyl triethylene glycol (“methyl triglycol”) and triethylene glycol n-butyl ether (“butyl triglycol”).

In one embodiment of the invention, aqueous polymers in particular polyurethane dispersions, do not comprise any propylene carbonate.

In a preferred embodiment, the at least one tie layer (B) is formed from an aqueous adhesive dispersion, generally a polymer dispersion, preferably a polyurethane dispersion, which comprises at least one crosslinking agent C, the at least one crosslinking agent C being at least one polyisocyanate P which is blocked with at least one blocking agent BA, as are defined above.

In one embodiment of the invention, aqueous polymer/polyurethane dispersions for the preparation of the at least one tie layer (B) comprise from 0.1 to 5% by weight of dipropylene glycol dimethyl ether and/or 1,2-propanediol diacetate.

In a particularly preferred embodiment, suitable crosslinking agents C are added, as 1 to 80% by weight solution in dipropylene glycol dimethyl ether and/or 1,2-propanediol diacetate, preferably as 30 to 75% by weight solution in dipropylene glycol dimethyl ether and/or 1,2-propanediol diacetate, to the aqueous polymer/polyurethane dispersions for the preparation of the at least one tie layer (B).

In a particularly preferred embodiment, polyisocyanate crosslinking agents C are added, as 30 to 75% by weight solution in dipropylene glycol dimethyl ether and/or 1,2-propanediol diacetate, to the aqueous polymer/polyurethane dispersions for the preparation of the at least one tie layer (B).

In an additional operation of the preparation process according to the invention, organic adhesive is preferably applied to polymer/polyurethane film (C) and/or backing (A), in fact either all over or not all over, for example in the form of points or strips. In an alternative form of the present invention, a preferably organic adhesive is applied to polymer film (C) and a preferably organic adhesive is applied to backing (A), the two adhesives differing, for example through one or more additives or because chemically different, preferably organic, adhesives are concerned.

Subsequently, in stage c), polymer film (C) and backing (A) are bonded, in fact so that the layer(s) of adhesive comes to lie between the polymer/polyurethane film (C) and backing (A). Adhesive or adhesives are cured, for example thermally, through actinic radiation or through aging, and multilayered composite material according to the invention is obtained.

It is possible to compress, for example using a calendar, in order to improve adhesion of polymer layer (C) to the other constituents of the multilayered composite system according to the invention. Suitable contact pressures can be in the range from 1 to 20 bar. Suitable contact times can be in the range from 10 to 200 seconds. Suitable contact temperatures can be in the range from 80 to 140° C.

Multilayered composite materials which have been prepared according to the process according to the invention exhibit agreeable visual and haptical properties and show surprisingly good mechanical properties, such as rubbing fastnesses or buckling strengths. In addition, they exhibit good functional properties and can be satisfactorily cleaned, for example by mechanical cleaning or chemical cleaning, for example using supercritical carbon dioxide or organic solvents, such as hydrocarbons or halogenated hydrocarbons.

In particular, they exhibit superior storage and aging properties, in particular hot light aging properties, and hydrolysis properties.

In addition, composite materials which have been prepared according to the process according to the invention exhibit a very constant quality, since the aqueous polymer dispersions used have a long shelf life.

It is one of the surprising results that the use of crosslinking agents C chosen from at least one polyisocyanate P which is blocked with at least one blocking agent BA improves the storage properties, aging properties and mechanical properties, without the visual and haptical properties being significantly impaired.

It is one of the surprising results that the use of polyisocyanates P blocked with at least one blocking agent BA results in composite materials which exhibit outstanding wear properties and mechanical strength.

Additionally, it has been shown that composite materials which have been prepared according to the process according to the invention were, after the preparation, immediately adhesive-free and could, after the preparation, be very quickly stacked, rolled up or otherwise stored.

### EXAMPLES

Backing materials used:
A.1. Knitted fabric 100% polyester, dyed beige
A.2. Knitted fabric 100% polyester, washed and mordanted, with smooth PU coating on one side colored black

### Example I.1

### Dispersion Mixture for the Tie Layer (B)

65 parts (all amounts and proportions in the experimental part are percentages by weight) of water were introduced at ambient temperature. 645 parts of an aqueous dispersion (solids content 40% by weight) of a polyester/polyurethane with a glass transition temperature of −46° C. were added to this with continuous stirring. 195 parts of an aqueous dispersion (solids content 62% by weight) of an acrylic acid/acrylonitrile copolymer with a glass transition temperature of −22° C. were added to this with stirring. 95 parts of an aqueous dispersion (solids content 40% by weight) of an anionic polyurethane with a Shore (A) hardness of 56 were added to this with stirring. The mixture was stirred for 15 minutes.

### Example I.2

### Dispersion Mixture for the Polymer Layer (C)

155 parts of water were introduced at ambient temperature. 445 parts of an aqueous dispersion (solids content 40% by weight) of an anionic aliphatic polyether/polyurethane with a Shore (A) hardness of 65 were added to this with continuous stirring. 365 parts of an aqueous dispersion (solids content 35% by weight) of an aliphatic anionic polyurethane were added to this with stirring. 35 parts of an aqueous dispersion (solids content 67% by weight) of a precrosslinked silicone rubber were added to this with stirring. The mixture was stirred for 15 minutes.

### Example I.3

### Dispersion Mixture for the Polymer Layer (C)

200 parts of water were introduced at ambient temperature. 725 parts of an aqueous dispersion (solids content 40% by weight) of an anionic aliphatic polyether/polyurethane with a Shore (A) hardness of 65 were added to this with continuous stirring. 75 parts of an aqueous dispersion (solids content 67% by weight) of a precrosslinked silicone rubber were added to this with stirring. The mixture was stirred for 15 minutes.

### Example I.4

### Dispersion Mixture for the Polymer Layer (C)

100 parts of water were introduced at ambient temperature. 465 parts of an aqueous dispersion (solids content 27% by weight) of an anionic aliphatic polyurethane, which comprised 2% of silicon dioxide as delustrant, were added to this with continuous stirring. 315 parts of an aqueous dispersion (solids content 40% by weight) of an aliphatic anionic polyurethane with a Shore (A) hardness of 56 were added to this with stirring. 65 parts of an aqueous dispersion (solids content 37% by weight) of an aliphatic anionic polyurethane with a Shore (A) hardness of 72 were added to this with stirring. 55 parts of an aqueous dispersion (solids content 67% by weight) of a precrosslinked silicone rubber were added to this with stirring. The mixture was stirred for 15 minutes.

### Example I.5

### Dispersion Mixture for the Polymer Layer (C)

120 parts of water were introduced at ambient temperature. 467 parts of an aqueous dispersion (solids content 27% by weight) of an anionic aliphatic polyurethane, which comprised 2% of silicon dioxide as delustrant, were added to this with continuous stirring. 375 parts of an aqueous dispersion (solids content 37% by weight) of an aliphatic anionic polyurethane with a minimum film forming temperature of 23° C. were added to this with stirring. 38 parts of an aqueous dispersion (solids content 67% by weight) of a precrosslinked silicone rubber were added to this with stirring. The mixture was stirred for 15 minutes.

### Example II

### Preparation of a Mold

A liquid silicone was poured onto a substrate which exhibited the pattern of a full-grain calfskin. Curing was allowed to take place by adding thereto a solution of di-(n-butyl)bis(1-oxoneodecyloxy)stannane as a 25% by weight solution in tetraethoxysilane as acidic curing agent, and a silicone rubber layer with an average thickness of 2 mm was obtained, which layer was used as mold. The mold was adhesively bonded to an aluminum support with a thickness of 1.5 mm.

### Example III

### Preparation of Formulations for the Application

For examples III.1 to III.10, the polymer mixtures from examples I.1 to I.5 according to table 1 were introduced and admixed with 2% by weight of a pigment formulation comprising Pigment Black 7 and nonionic surfactants (2% by weight, based on the polymer dispersion used). A the amount stated in table 1 of a solution of an anionic polyisocyanate based, on 1,6-hexamethylene diisocyanate (stated percentage based on the polymer dispersion used) which was blocked with 3,5-dimethylpyrazole (solids content of the solution 40%, NCO content of the free polyisocyanate, based on the solution used, 4.8%) was added to this. The mixture was stirred at ambient temperature for 15 minutes.

TABLE 1
Composition of the polymer dispersions used for the application of polymer and tie layers

| No. | III.1 | III.2 | III.3 | III.4 | III.5 | III.6 | III.7 | III.8 | III.9 | III.10 |
|---|---|---|---|---|---|---|---|---|---|---|
| Polymer | I.1 | I.2 | I.3 | I.4 | I.5 | I.1 | I.2 | I.3 | I.4 | I.5 |
| dispersion | | | | | | | | | | |
| Amount of polyisocyanate | 4 | 5 | 5 | 5 | 5 | 2 | 2.5 | 2.5 | 2.5 | 2.5 |
| used [% by weight, based on | | | | | | | | | | |
| the polymer dispersion used] | | | | | | | | | | |

Moreover, the following comparative tests were carried out:

For examples III.11 and III.12, the polymer mixtures from examples I.1 and I. 2 according to table 2 were introduced and admixed with 2% by weight of a pigment formulation comprising Pigment Black 7 and nonionic surfactants (2% by weight, based on the polymer dispersion used). The amount stated in table 2 of a solution of an anionic polyisocyanate based on 1,6-hexamethylene diisocyanate (stated percentage based on the polymer dispersion used) which was not blocked (solids content of the solution 40%, NCO content 4.8%) was added to this. The mixture was stirred at ambient temperature for 15 minutes.

TABLE 2
Composition of the polymer dispersions used as comparative
examples for the application of polymer and tie layers

| No. | III.11 | III.12 |
|---|---|---|
| Polymer dispersion | I.1 | I.2 |
| Amount of polyisocyanate used | 4 | 5 |
| [% by weight, based on the | | |
| polymer dispersion used] | | |

IV. Preparation of Multilayered Composite Materials According to the Invention

The mold from example II. was placed on a heatable substrate and heated to 91° C. An aqueous polymer dispersion according to table 3 was subsequently sprayed on to it by a spraying nozzle, in fact 100 g/m² (wet). The application was carried out without addition of air using a spray nozzle which had a diameter of 0.46 mm, at a pressure of 65 bar. Solidification was allowed to take place at 105° C.

The spray nozzle was arranged in movable fashion at a height of 20 cm from the continuous substrate in the direction of movement of the same and moved at right angles to the direction of movement of the substrate. The substrate had passed the spray nozzle after approximately 14 seconds and had a temperature of 59° C. After supplying with dry air at a temperature of 85° C. for approximately 2 minutes, the polyurethane film (C.1) thus prepared having a network-like appearance, was virtually free from water.

In an analogous arrangement, 50 g/m2 wet of a polymer dispersion according to table 1 were immediately afterwards applied as tie layer (B.1) to the mold thus coated and drying was subsequently allowed to take place at 105° C.

A mold coated with, polyurethane film (C.1) and tie layer (B. 1) was obtained.

A backing material according to table 2 was likewise sprayed with 50 g/m² wet of the same polymer dispersion (B) as tie layer (B.2). The polyester fabric thus sprayed was allowed to start drying at ambient temperature for several minutes. A backing material coated with tie layer (B.2) was obtained.

The mold with polymer layer and tie layer and the respective backings with a tie layer were subsequently overlaid using an installation (e.g. laminating unit) as follows (table): the mold with polymer layer and tie layer and the respective backings were heated in three regions, each 2 meters in length, with 140° C., 160° C. and 170° C. one after the other, and subsequently laminated with a contact pressure of 6 N/cm² and an opening of 6.5 mm. The patterns were subsequently run with a velocity of 5 m/min through a cooling section with a length of 2 meters at a retooling temperature of 30° C.

TABLE 3
Composite materials IV.1 to IV.16 prepared according to
the invention and comparative examples IV.17 to IV.18

| Test No. | Backing | Tie layer (B) | Polymer layer (C) |
|---|---|---|---|
| IV.1 | A.1 | III.1 | III.2 |
| IV.2 | A.1 | III.1 | III.3 |
| IV.3 | A.1 | III.1 | III.4 |
| IV.4 | A.1 | III.1 | III.5 |
| IV.5 | A.1 | III.6 | III.7 |
| IV.6 | A.1 | III.6 | III.8 |
| IV.7 | A.1 | III.6 | III.9 |
| IV.8 | A.1 | III.6 | III.10 |
| IV.9 | A.2 | III.1 | III.2 |
| IV.10 | A.2 | III.1 | III.3 |
| IV.11 | A.2 | III.1 | III.4 |
| IV.12 | A.2 | III.1 | III.5 |
| IV.13 | A.2 | III.6 | III.7 |
| IV.14 | A.2 | III.6 | III.8 |
| IV.15 | A.2 | III.6 | III.9 |
| IV.16 | A.2 | III.6 | III.10 |
| IV.17 | A1 | III.11 | III.12 |
| IV.18 | A2 | III.11 | III.12 |

V. Performance Testing of the Composite Materials Prepared According to Example IV.

The composite materials prepared according to test IV.1 to IV 16 were subjected to the following investigations:
1. Wear test
   Veslic wear tester (Veslic=Verein Schweizerischer Lederindustriechemiker) according to ISO 11640 and DIN 61200
   weight 500 g
   a.) with felt, wet—media liquid water—500 cycles
   b.) with felt, dry, 2000 cycles
2. Fleximeter testing (Bally Flex)
   according to DIN EN ISO 5402, DIN 53351
   100 000 cycles
3. Martindale (scrub resistance)
   following DIN EN ISO 12947-1
   with a weight of 12 kPa
   20 000+50 000 cycles
4. Hydrolysis testing
   according to DIN 53504
   (95% ambient humidity, 70° C., 500 h)
   subsequently Martindale 50 000 cycles
5. Hot light aging
   according to ISO 105-B06
   3-times—210 h
   subsequently 30 000 cycles
6. Stacking test
   Testing device according to DIN EN ISO 15701 (migration fastness)

After the investigations, the test specimens were graded:

| Grade: 1 | Grade: 2 | Grade: 3 | Grade: 4 | Grade: 5 |
|---|---|---|---|---|
| Surface | Surface up to | Surface with | Surface without | Surface without |
| completely | 50% destroyed, | slight damage, | damage, with | damage and without |
| destroyed, | backing can be | the backing can | signs of wear | signs of wear |
| backing is free | seen | be partially seen | and tear | and tear |

TABLE 4
Testing results of composite materials IV.1 to IV.16 and of comparative
examples IV.17 and IV.18: 1. Wear test according to Veslic (a: wet, b: dry);
2. Flexometer testing (Bally); 3. Scrub resistance according to Martindale;
4. Hydrolysis testing according to DIN 53504; 5. Hot light aging according
to ISO 105-B06; 6. Stacking test according to DIN ISO 11641

| Mold | | | | | | | | | |
|---|---|---|---|---|---|---|---|---|---|
| -V- | Back- | 1. | | | 3. | | | | |
| No.: | ing | Wet | Dry | 2. | 20 000 | 50 000 | 4. | 5. | 6. |
| IV.1 | A.1 | 4 | 4-5 | 4-5 | 4-5 | 4 | 4 | 4 | 4-5 |
| IV.2 | A.1 | 4 | 4-5 | 4-5 | 4-5 | 4 | 4 | 4 | 4-5 |
| IV.3 | A.1 | 4 | 4-5 | 4-5 | 4-5 | 4 | 4 | 4 | 4-5 |
| IV.4 | A.1 | 4 | 4-5 | 4-5 | 4-5 | 4 | 4 | 4 | 4-5 |
| IV.5 | A.1 | 4 | 4-5 | 4-5 | 4-5 | 4 | 4 | 4 | 4-5 |
| IV.6 | A.1 | 4 | 4-5 | 4-5 | 4-5 | 4 | 4 | 4 | 4-5 |
| IV.7 | A.1 | 4 | 4-5 | 4-5 | 4-5 | 4 | 4 | 4 | 4-5 |
| IV.8 | A.1 | 4 | 4-5 | 4-5 | 4-5 | 4 | 4 | 4 | 4-5 |
| IV.9 | A.2 | 4 | 4-5 | 4-5 | 4-5 | 4 | 4 | 4 | 4-5 |
| IV.10 | A.2 | 4 | 4-5 | 4-5 | 4-5 | 4 | 4 | 4 | 4-5 |
| IV.11 | A.2 | 4 | 4-5 | 4-5 | 4-5 | 4 | 4 | 4 | 4-5 |
| IV.12 | A.2 | 4 | 4-5 | 4-5 | 4-5 | 4 | 4 | 4 | 4-5 |
| IV.13 | A.2 | 4 | 4-5 | 4-5 | 4-5 | 4 | 4 | 4 | 4-5 |
| IV.14 | A.2 | 4 | 4-5 | 4-5 | 4-5 | 4 | 4 | 4 | 4-5 |
| IV.15 | A.2 | 4 | 4-5 | 4-5 | 4-5 | 4 | 4 | 4 | 4-5 |
| IV.16 | A.2 | 4 | 4-5 | 4-5 | 4-5 | 4 | 4 | 4 | 4-5 |
| IV.17 | A.1 | 2 | 3 | 4-5 | 3-4 | 3 | 3 | 3 | Adhesively bonded |
| | | | | | | | | | together, cannot |
| | | | | | | | | | be separated |
| IV.18 | A.2 | 2 | 3 | 4-5 | 3-4 | 3 | 3 | 3 | Adhesively bonded |
| | | | | | | | | | together, cannot |
| | | | | | | | | | be separated |

1. A process for the preparation of multilayered composite materials comprising, as components:
(A) a backing material,
(B) optionally at least one tie'layer and
(C) a polymer layer,
the method comprising:
a) forming a polymer layer (C) with a mold;
b) optionally applying at least one organic adhesive all over or partially to backing material (A) and/or to polymer layer (C); and then
c) bonding polymer layer (C) with backing material (A) in point, strip or two-dimensional fashion,
wherein the polymer layer (C) and/or the optionally at least one tie layer (B) prepared from aqueous polymer dispersions which comprise at least one crosslinking agent C, the at least one crosslinking agent C being at least one polyisocyanate P, the isocyanate groups of which are blocked at ambient temperature with at least one blocking agent BA.

2. The process according to claim 1, wherein the polymer layer (C) is a layer of polyurethane, polyvinyl acetate or mixtures thereof.

3. The process according to claim 1, wherein the polymer layer (C) is a polyurethane layer.

4. The process according to claim 1, wherein the aqueous polymer dispersions comprise at least one crosslinking agent C, the at least one blocking agent BA being chosen from malonic esters, acetoacetates, oximes, pyrazoles, lactams and phenols.

5. The process according to claim 3, wherein the polyurethane layer (C) exhibits capillaries which extend over the entire thickness of the polyurethane layer (C).

6. The process according to claim 1, wherein the backing material (A) is at least one selected from the group consisting of leather, textiles, nonwovens, artificial leather, foams, cellulose materials, stone, metal films and plastic films.

7. The process according to claim 3, wherein the polyurethane layer (C) exhibits a pattern.

8. The process according to claim 3, wherein the polyurethane layer (C) exhibits a velvety appearance.

9. The process according to claim 1, wherein the tie layer (B) is an open-work layer of a cured organic adhesive.

10. The process according to claim 3, wherein polyurethane layer (C) is formed with a silicone mold or a mold made of EPM or EPDM.

11. The process according to claim 10, wherein the silicone mold is a silicone mold structured using laser engraving.

12. The process according to claim 1, wherein wells are incorporated in the mold in the structuring of the mold using a laser, wherein the wells exhibit an average depth in the range from 50 to 250 μm and a center-to-center separation in the range from 50 to 250 μm.

13. A multilayered composite material, obtained by the process according to claim 1.
